(19) United States
(12) Patent Application Publication
(10) Pub. No.: US 2007/0242225 A1
(43) Pub. Date: Oct. 18, 2007

(54) Sleep mode display system

(76) Inventors: Maureen Bragg, Napa, CA (US); Robert Carr, San Francisco, CA (US); Germaine Ward, Mt. Pleasant, SC (US)

Correspondence Address: FLIESLER MEYER LLP, 650 CALIFORNIA STREET, 14TH FLOOR, SAN FRANCISCO, CA, 94108, US

(21) Appl. No.: 11/582,182

(22) Filed: Oct. 17, 2006

Related U.S. Application Data
(60) Provisional application No. 60/728,090, filed on Oct. 18, 2005.

(51) Int. Cl. G03B 31/04

(52) U.S. Cl. 352/12

(57) ABSTRACT

An integrated system to create relaxation in preparation for sleep, embodiments of the invention projects digital video content onto the ceiling or a wall while playing a synchronized audio track to engage the user. Content for the system is specially designed to create relaxation in preparation for sleep by engaging the user's interest with engaging stimulation content, transitioning to mild stimulation content, and then to low stimulation content. Higher stimulation content tracks would contain material that includes more activity, more colors, and the music more stimulating. The mild stimulation segment includes audio and video that has less movement and activity, fewer colors, and slower audio. The low stimulation content is designed to be low activity, and relaxing in nature so as to encourage relaxation and sleep. This segment is followed by content tagged as the nightlight segment. This would include video only of a stationary image, or almost stationary with occasional movement designed to comfort—but not stimulate or awaken. This segment would last all night long.

### CLAIM OF PRIORITY

This application claims the benefit of U.S. Provisional Patent Application 60/728,090 entitled SLEEP MODE DISPLAY SYSTEM, by Maureen Bragg and Robert Carr, filed Oct. 18, 2005, the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This invention projects digital video content onto the wall or ceiling while playing a synchronized audio track to create relaxation in preparation for sleep.

### BACKGROUND

Insomnia is a widespread problem, affecting almost half of the adult population, according to the National Sleep Foundation. The problem may be that people are stressed or worried and cannot quiet their mind. Alternatively, people may be too stimulated by their day's activities and have not yet relaxed enough. Although most people watch television before bed, sleep experts feel television is stimulating and thus does not aid in relaxation in preparation for sleep.

For seniors, many experience sleep problems associated with medical conditions and the physical changes associated with aging. Nighttime aches and pains may impact their ability to fall asleep. The increased need to use the bathroom during the night means more nighttime awakenings.

Children also experience sleep problems. Like adults, many children are still stimulated from their day and do not want to retire at bedtime. Many young children (toddlers, preschoolers and early grade-school children) engage in bedtime battles with their parents by stalling and resisting going to bed. Frustrated parents are losing their own personal evening downtime as a result.

In addition, many young children rely on the comfort of a parent staying in the room with them until they fall asleep. The problem is compounded because the child seeks out the parent when they wake up during the night. Children need to learn to put themselves to sleep. Once children lie down and stay down, most fall asleep within 20 minutes. Children that can put themselves to sleep are less likely to wake their parents in the middle of the night.

One popular partial solution to the need to relax and transition to sleep are audio-only “soothers” with built-in white noise and nature sounds such as ocean waves or nighttime crickets. Some soothers are dedicated white noise machines; others are integrated into nightstand alarm clock/CD players.

Previously there have been a plethora of projection devices that work with digital content, but they have typically been standalone devices working with either standard audio visual component equipment such as DVD players, or business LCD projectors working with computers to project images in business meeting rooms. The primary purpose of these projection units is to facilitate viewing in a group situation so everyone present sees the screen at once. There are a plethora of playback devices such as portable DVD players that accept digital content (audio, visual or a combination), but they typically play the visuals on an embedded screen or attached monitor and there is no way for these devices to locate their image on the ceiling.

### BRIEF DESCRIPTION OF THE DRAWINGS

FIG. 1A shows the exterior of one embodiment of the invention presented as an elephant.

FIG. 1B shows a top view of the embodiment of FIG. 1A.

FIG. 1C shows a front view of the embodiment of FIG. 1A.

FIG. 1D shows a side view of the embodiment of FIG. 1A.

FIG. 2 depicts the interior of the embodiment of FIG. 1A.

FIG. 3 is a block diagram showing an example of a hardware configuration of an embodiment of the invention.

FIG. 4 depicts the interior of an embodiment of the invention designed for adults.

FIG. 5 is a process flow depicting how an embodiment of the invention can help a user fall back to sleep.

FIG. 6 is a process flow depicting how an embodiment of the invention creates relaxation in preparation for sleep.

FIG. 7A shows the exterior of an embodiment of the invention designed for adults.

FIG. 7B shows a top view of the embodiment of FIG. 7A.

FIG. 7C shows a front view of the embodiment of FIG. 7A.

FIG. 7D shows a side view of the embodiment of FIG. 7A.

FIG. 7E shows a back view of the embodiment of FIG. 7A.

FIG. 8 shows another embodiment of the invention designed for children, presented as a train.

FIG. 9 shows another embodiment of the invention designed for children, presented as a puppy.

### DETAILED DESCRIPTION

Embodiments of the invention combine the novel concept of projecting computerized digital moving images on a wall or ceiling along with synchronized audio to aid in relaxation and the transition to sleep. The result is an entirely new category of digital playback device one might call a nighttime audio and visual soother. The device is unique in that it is an integrated system designed for individual use that combines digital playback and projection, specially developed content for relaxation, and options to accommodate user preferences relating to their personal sleep environment.

Embodiments of the invention can project a moving image onto the wall or ceiling for the purpose of relaxation and sleep. The device's design allows for the image to easily be projected onto the ceiling, allowing the child or adult to rest prone in bed with their head on the pillow without needing to hold or support the device. The device is optimized to work in a completely darkened bedroom (e.g., the projection luminance is much dimmer than traditional audiovisual or business projectors), and the child or adult can rest in their bed in a position with head on pillow or otherwise arrayed to be comfortable and in their usual sleep position.

Embodiments of the invention are designed to help users relax in bed. Embodiments produce synchronized images and audio that is projected onto the ceiling or wall while the user is lying down.

Unique to embodiments of this invention are the ways in which the content is developed and played. The content is specially developed to be relaxing by progressively reducing the level of stimulation. Using a content tagging scheme, the invention is programmed to play different tracks and sequences, based on the content, user preferences and commands.

System defaults can be customized by the user (or parent in the case of a child). These preferences allow the user to customize the experience to accommodate environmental factors such as brightness and other aspects such as duration of play and alarm settings to their personal liking. Preference settings are accessed through a menu with options presented on an LCD screen or projected on the ceiling.

Additional functions are designed specifically for a child's version, such as “Read-to-me” mode and a lockout that prohibits the child from initiating the unit.

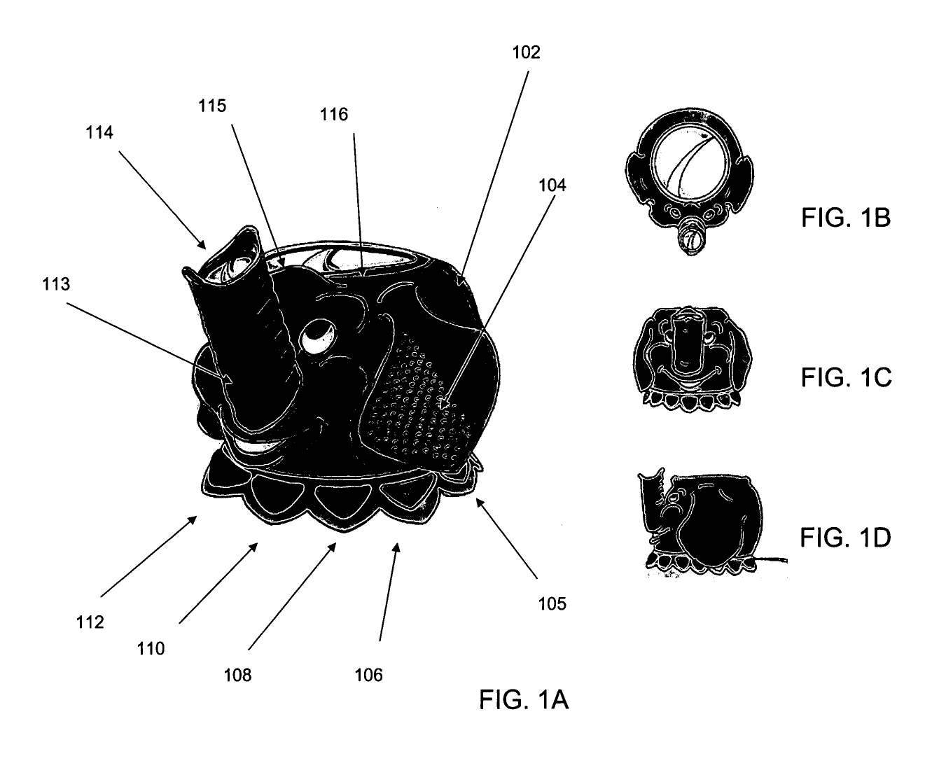

User commands such as on/off, forward/back and snooze are easily accessed by pressing buttons on the front of the unit or through a separate remote control. Child versions can make use of clever housing designs and incorporate these buttons into the concept, such as the elephant's collar in FIG. 1.

Housing is specific to the target audience. Versions for children can incorporate casings such as animals and other childhood designs such as trains, fire trucks and playhouses. Teen and adult versions can incorporate trendy colors and designs, much like today's cellular phones and MP3 players.

For the children's market, variations in housing and internal components can accommodate different market objectives and retail price points. Some configurations may focus exclusively on fixed content that is tightly tied to the housing design. For example, a “Princess” model that uses princess stories and other princess-related content. This incarnation would allow themed marketing and reduce cost of goods at the same time. Other incarnations may eliminate the CD/DVD drive, yet enable support for external devices.

Operating the device is as follows. Fixed content, such as nature scenes with audio, is preloaded and permanently stored on the device. Additionally, users can play content from their personal library by inserting a CD/DVD, downloading content or accessing an external device. The user's content can be commercially produced or user generated, such as photos and home videos. The projector on the embodiment of the invention can pivot or rotate so that the visual content can be displayed on a ceiling or wall as the user desires.

Fixed content and commercially produced content will contain synchronized visuals and audio. In cases where the user provides audio content without video (such as inserting a CD), the system will generate abstract visuals (similar to computer media players) relating to the tempo of the user's audio content. If the user provides video content without audio (such as photos or home videos), the system will play the fixed audio content.

The projector may be comprised of a light source shining through a transparent computer display such as an LCD panel, or through focusing optics with the effect of creating an image on a wall or ceiling. The projector is optionally integral to the device (e.g., housed or permanently attached to the same physical unit which houses the content playback device).

The projected visuals may include but are not limited to computer graphics animation or video. The visuals can have color depth, or grey scale, or be monochromatic (e.g., black and white, or black and red). Visuals are optionally displayed in silhouette (black profile against white/red background, or white/red against black background), achieving the effect of projected “shadows.” The visuals are accompanied and synchronized with appropriate audio.

The visuals have an invert mode that has the effect of flipping darks and lights (e.g., switching from black and red to inversion, which would be red and black). The invert mode is valuable because it allows white or red “shadows” to be projected against a black background, whereby the black background blends seamlessly in with the darkened ceiling in the bedroom. The above-mentioned substitution of red color for white is valuable because red is the only color that does not disturb night vision and is probably also therefore physiologically more rest-inducing and less stimulating.

Color modes and inversions may be technically achieved by either having multiple versions of the content tracks pre-developed, or by applying dynamic color filters to change the colors of the content in a post-processing step. Such a post-process filter could be software processing or electronic filtering or physical processing such as using different LED light sources or colored lenses. For grey-scale or monochromatic modes, the device has a mode which cycles through colors automatically at random or short intervals.

Embodiments can apply special stylized filters to the visuals to create different effects such as soft focus and duatone, or artistic affects such as an impressionistic painting or a black and white sketch. For example, a senior may enjoy looking at family photos displayed in a dreamy, impressionistic style.

A content tagging scheme provides the method for the invention to determine the selection and sequence of tracks for playback. Content tags include, but are not limited to, engaging, chapter, mild, low, nightlight and wake-up. An engaging content tag specifies that the content it to be played first. A chapter content tag signifies that the engaging content is prepared in multiple tracks. The system plays one chapter each night and records the current location. A mild content tag indicates content with less stimulation than the engaging content and is played after engaging content. In the event that there is no engaging content present, mild content would be played first. Content tagged as low stimulation is played last, may be repeated and is used for nighttime awakenings. The nightlight tag is used for visuals that remain on throughout the night. The wake-up tag is used for content that is played when the alarm is triggered.

When the play button is pressed, the embodiment automatically plays the user's content if found. If not found, the embodiment plays fixed content. Content is played in accordance with the user-defined preferences. For example, the duration of play can be limited or extended with the timer and loop functions. In situations where the content repeats, the invention is designed to replay tracks that are tagged as “low stimulation.”

At the completion of the content, a final scene can be projected as a “nightlight.” Designed to aid in nighttime awakenings, the nightlight provides a comforting image with very little movement. To help the user get back to sleep, a “snooze” button plays “low stimulation” content for a predetermined number of minutes, then returns to the nightlight (if enabled on the preferences menu).

The system can also aid in waking up the user by playing engaging stimulation content developed specifically for the alarm mode and included as a “wake up” track that is contextually tied into the content. Using a train story content example, the wake up content could mimic a train conductor's announcement for an upcoming station. When the alarm buzzer or content is playing, the snooze button resets the alarm forward a predetermined number of minutes.

### Content for Young Children

In a darkened room, with the child lying in bed in a sleeping position, an embodiment of the invention can project images with a coordinated audio track. The content is preferably approximately 30 minutes in length and designed so that it progressively becomes less stimulating as the content moves from one sequence (track) to another.

From a content development perspective, young children present a unique challenge because they stall and resist going to bed. For this audience, the initial segment needs to be engaging enough to compel the child to lie down in bed.

The examples below present a number of “scenarios” for content developed specifically for young children. They illustrate how the technique of progressively reducing stimulation can be employed across a wide variety of content.

Stories—The child sees static pictures or moving images on the ceiling, while an audio track reads the story. This experience is the closest to reading a book. For chapter books, content can be tagged so an individual chapter is read as the engaging initial track each night. Provided the content has not been removed, the next chapter will be set up for the following night.

The parent can incorporate the invention into their bedtime reading time with their child. Using the “read-to-me” feature, the parent can mute the reading voice, while retaining any background sounds and music. The parent reads from the physical book while the child sees the projected images. The embodiment optionally plays the music track and projects one scene from the book at a time. The parent reads the book's text in place of the narration track. The reader can optionally choose to control the device to advance to projecting the next illustration (by means of on-device or remote control button). This “parent reading” mode has the advantage that the child is prone in bed looking at the projected illustrations with no need for the parent or child to twist and turn to see illustrations in the traditionally-printed book.

Stories with character dialogue can also be used for the initial sequence, provided the stories are developed with the appropriate level of stimulation. Some animated shows for the very young have short, simple stories that could work in this context. Using well-loved characters, children will feel comfortable with the content and be less resistant to getting into bed.

Once the story or chapter is complete, the content moves onto a less stimulating track, ideally tied into the story that has just been completed. For example, the engaging stimulation content might be the story of “The Little Engine that Could,” with engaging graphics of the train climbing the hill while the audio track includes the narrated story and music. The mild stimulation content might then include the conductor inviting the viewer inside the train, where the graphics involve a lesser number of colors, and the audio track and music are milder. The low stimulation content might have the viewer looking out the window of the train at a peaceful nature setting, with the music on the audio track containing soothing tones without any words. The nightlight function that follows the low stimulation track might have the sun setting and replaced by stars. The transitions between different stimulation levels should occur in a pleasing, soothing flow with more and more elements being removed from the viewer to reduce engagement.

Gender-Specific Content—While girls and boys may share interests in nature and animals, by preschool their interests are diverging. Little girls are enthralled by princess stories. Content such as dance sequences of their favorite princesses can serve as the compelling first sequence, which can be followed by less stimulating content such as watching the princess take a walk, followed by a relaxing nature scene. Little boys who are interested in cowboys, trains, spaceships and the like can have a similar experience. For example, the content may present a spacewalk, followed by scenes without gravity, followed by images of space.

Animals—Animals provide a wealth of content. Animals are interesting to watch and their movements can be easily set to music. In the engaging stimulation segment, the child watches the animal run and play, in the next segment they watch the animal fall asleep, and the final segment evolves to the surrounding landscape scene. Simple educational concepts can be incorporated into the initial content as well—for example, “Animals of Africa,” “Beneath the Sea” and so forth.

### Content for Teens and Adults

Teens and adults are also over-stimulated and have difficulty winding down before bed. Stress and physical discomfort can also impact their ability to fall asleep. Seniors are more likely to have nighttime awakenings due to bladder needs and physical discomfort.

For this audience content would be a bit longer in length, approximately 45-50 minutes. Unlike content for children, the initial segment does not have to be engaging. Instead it can be mildly stimulating and then move on to content that is even more relaxing.

Nature—Nature scenes are known to be relaxing. In addition to scenes of oceans, waterfalls, rainforests, streams, woods and so forth, seasonal nature scenes could incorporate elements such as spring blooms, falling leaves, and winter snow.

Sports—Sports can also be interesting content—divers, marathon runners, rock climbing, scuba—all of these can provide a relaxing presentation and be set to music. To reduce stimulation, images can move from the activity to the landscape.

Abstracts—Abstract designs (similar to screen saver images) can be presented with synchronized audio. The images and audio can be developed together or separately. For example, if the user loads music, the invention can generate images that coordinate with the tempo of the music.

Photos/Videos—Personal content, such as photos and home videos, also provide content. Accompanying audio can be played by selecting one of the fixed-content choices.

Generally, the present invention projects digital video content onto the ceiling while playing an audio track to create relaxation in preparation for sleep. One skilled in the art can envision numerous configurations and alternatives for the components of the system.

More specifically, FIG. 1A describes the exterior of one embodiment of the invention designed for children. The housing 102 of the self-contained system is designed to be masked in a variety of shapes to appeal to a wide variety of children and adults (elephants, trains, castles, etc.). The housing is designed to accommodate an integration of a display system, digital media storage, digital media player, and audio system. The projector 114 of the embodiment of the invention is specifically designed to be able to project content onto the ceiling (optimally) or a wall, by having the ability for the projector column 113 to pivot or rotate.

After turning the embodiment of the invention on by pressing the on/off button 106, the user places a CD or DVD in the player 116 and then presses the play button 110. Music and other audio content plays out of the audio speakers 104 while the video is projected onto the ceiling from the projector 114. Additional user controls allow the user to change the volume 105, select content source 108, skip to next track 110, and select play mode 112 (Video only, Audio Only, Read-to-me Mode, Nightlight Mode). The user can read the time of day on the LCD Panel Display 115.

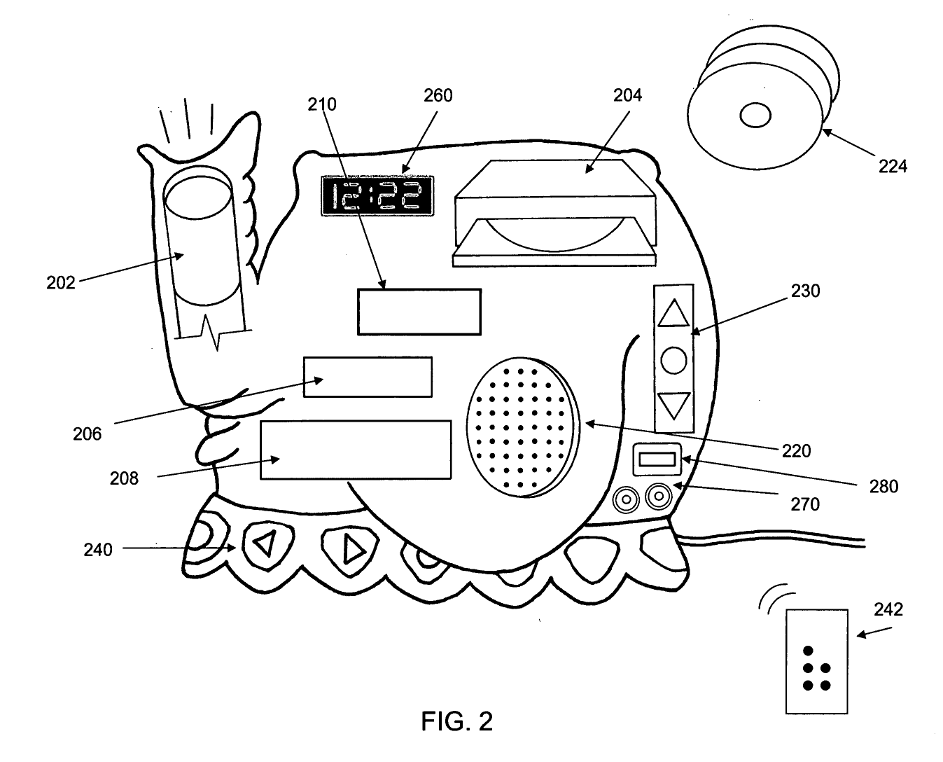

FIG. 2 shows the CPU 208, which consists of a set of application-specific integrated circuits (ASICs), ROM, signal drivers and other circuitry to control the signals and direct the appropriate signals (data) to the appropriate output devices (digital display system, and/or audio system). The CPU decodes the content data from the digital media storage sources and extracts the audio and video image data. The CPU then sends the appropriate electrical signals to a digital display system, such as an LCD and/or projector 202) to display the video image data. The CPU also sends the electrical signal to an amplifier which produces audio sound synchronized with the video through the speakers 220. The CPU monitors the user controls 240 to ensure it is playing the content selections and tracks in accordance with the user-defined preferences 230. User-defined preferences 230 are a set on buttons that correspond to menu choices for system defaults and preferences. The user controls 240 turn the invention on or off, adjust the volume and skip forward and back to the next track in the content. In addition, ROM 206 contains preloaded or fixed media content (audio and video) that is processed through the CPU to send the appropriate signals to the appropriate output devices. User content can also be downloaded onto Flash chips from a USB device through the USB connector 280 in FIG. 2.

The projector 202 is positioned to project an image on a horizontal surface (such as a ceiling) and can also be positioned to project an image on a vertical surface by having rotational capability of approximately 90 degrees. One skilled in the art recognizes that there are several different alternatives for the functioning of a projection system. One embodiment is comprised of a light source shining through a transparent computer display such as an LCD panel, through focusing optics to project an image on the wall or ceiling. The projector is shown positioned to project an image on a horizontal surface such as a ceiling.

Aromatherapy cartridge system 210 gently warms fragrance-infused gel cartridges so that scent is released gradually.

Audio system 220 is comprised of amplifier and speakers designed to accept the electrical signals from the CPU to produce audio sound through the speakers, synchronized with the video or images. In addition, external speakers or headphones could also be connected via the audio jacks 270.

Digital media playback device 204 can be a CD (compact disk) or DVD (digital video disk) disc player. The CD or DVD disk contains the content which is sent to the CPU by the disc player to be decoded. The CPU extracts audio and/or video data, which are then sent to either the display system (video and/or images) or the speaker system (audio).

External digital media sources may include, but are not limited to, portable music/video players (iPod), computer or the Internet. These external devices are connected to the invention via a USB port 280. The content is then sent to the CPU to be decoded and then displayed and/or heard.

An LCD panel 260 displays the time of day (digitally, hours and minutes) and is used to display icons indicating preference settings. This is also programmable to include an alarm which could be programmed to awaken the user to a certain sequence of the audio and video content on the user's content or ROM/Flash chips through the speakers and display system above.

The embodiment also includes a remote control 242 which enables the user to access and adjust the user controls 230 remotely.

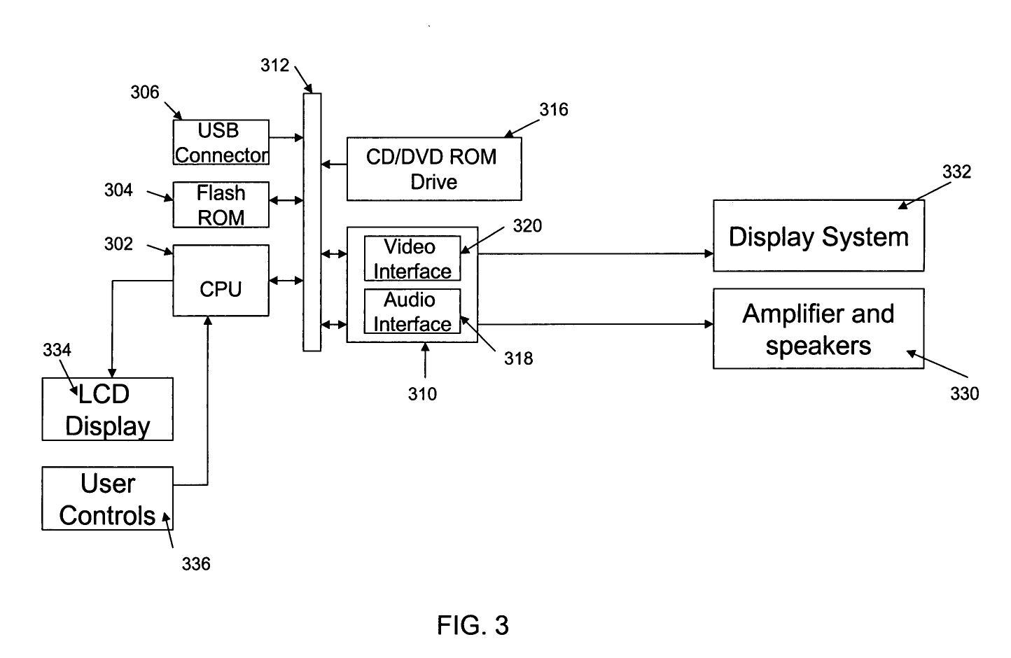

FIG. 3 is a block diagram showing an example of a hardware configuration of the embodiment of the invention. The embodiment of the invention has a built-in CPU 302 for controlling the entire embodiment of the invention. A flash ROM 304, USB connector 306, and a signal processing section 310, are connected to the CPU 302 through a data bus 312.

The CPU 302 performs several kinds of processes through firmware that is programmed to respond to user preferences and user operations (such as pushing the play mode button). The CPU 302 directs data to the appropriate devices to be decoded and processed.

The USB connector 306 controls data communication between the embodiment of the invention and the devices connected through the USB connector 306, such as iPods, computers and other external devices.

The CD/DVD ROM drive 316 reads out audio and video data recorded on the music or video CD (not shown) once inserted into the CD/DVD drive 316 by the user.

The signal processing section 310 includes an audio interface 318 and a video interface 320, which supply the audio data to the amplifier and speakers 330 and the video data to the display system 332.

The LCD display 334 is connected to the CPU 302 and displays the time (hours/minutes) as well as well as menu choices for the user controls 336.

The user controls 336 are connected to the CPU, which responds to the operation of the user by directing a function that can be executed by the embodiment of the invention.

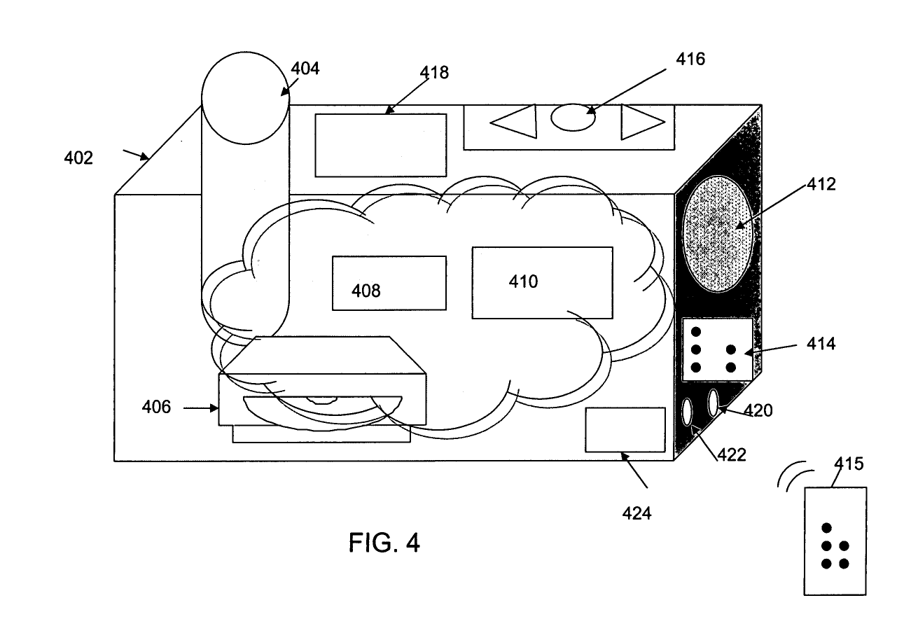

FIG. 4 is a functional view of an interior of another embodiment of the invention. The housing 402 contains the entire system, including the projector unit 404 which can pivot or rotate to project the images on the ceiling or the wall. The CD or DVD player 406 is designed for easy access by the user. The system is controlled by the ROM 408 and the CPU 410. For audio, there are internal speakers 412. Controls for the embodiment are located in several locations; the front controls 416 have a subset of functionality for the child and the back controls 414 have additional functionality for the parents. A remote control 415 is included to enable the user to access and adjust the user controls or front controls 416 separately. An LCD panel 418 displays the time and other information. Additional external components can be plugged into the embodiment of the invention through the audio output jacks 420 and the USB connection 422. Aromatherapy cartridge system 424 gently warms fragrance-infused gel cartridges so that scent is released gradually.

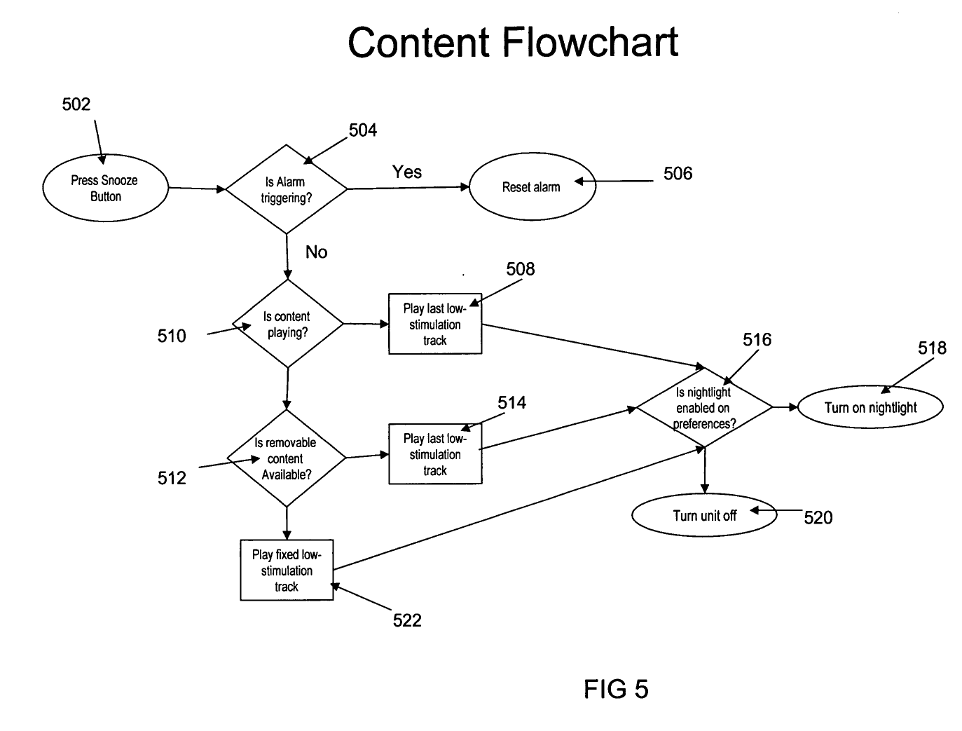

FIG. 5 describes a process flow for nighttime awakenings when the user needs help to fall back to sleep. If there is user-provided content 510 that is not currently playing 512, the unit will play the last low-stimulation track 508 in the content segment before sequencing to the nightlight segment (if enabled) 516 and 518. If there is no user-provided content 512, the unit will look for removable content (via an iPod or other device connected to the unit via a USB connection) and play the last low-stimulation track 514, before proceeding to the nightlight function 516 if enabled 518, or turning the unit off if the nightlight is not enabled 520. If removable content is not available 512, the unit will default to the fixed, pre-loaded content and will play the last low-stimulation track 514 before progressing to the nightlight function 516,518 if enabled or turning the unit off 520 if the nightlight function is disabled. In the case where the user provided content 510 is currently playing, the unit will jump to the last low-stimulation track 508 in the content segment before sequencing to the nightlight segment (if enabled) 516 and 518 or turning the unit off 520 if the nightlight function is disabled. This process could also be followed in the case of a snooze scenario, when the user wishes to reset the alarm 502 when triggering 504 for additional minutes of sleep.

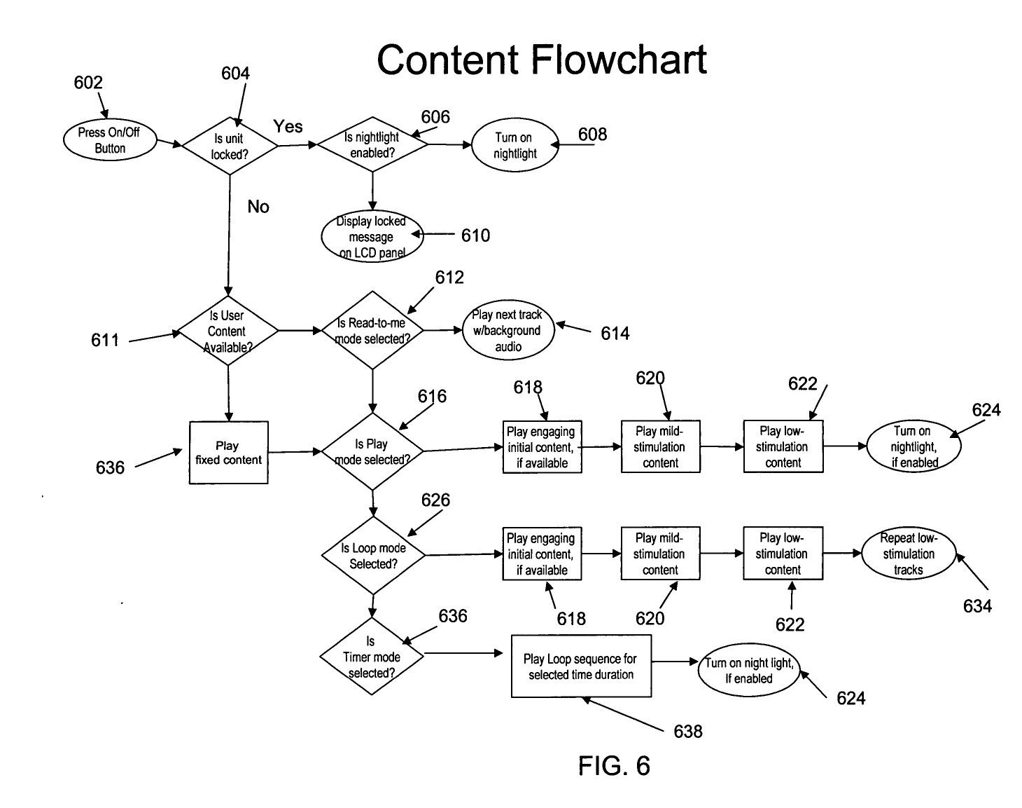

FIG. 6 illustrates the use of the system for creating relaxation in preparation for sleep. It starts with the unit being turned on 602. If the unit controls are locked 604 (pre-set by the parent for example), the nightlight function (if enabled 606) is turned on 608. If the nightlight is not enabled, a message will be displayed on the LCD panel 610 indicating the unit is locked and no further action is taken. If the unit is not locked 604, the unit checks what type of content to play. If user-provided content (via CD, DVD, or other) is present 611, it looks to determine the mode of play. If the Read-To-Me mode 612 is selected, the unit plays the next track with the background audio track 614. If Read-To-Me mode 612 is not selected, the unit looks to see if Play mode selected 616. If yes, the initial engaging-stimulation content tracks 618 will play, which last approximately 5-7 minutes. This content engages interest through projecting engaging stimulation video content on the ceiling while playing synchronized music and audio content. The next content type is a mild-stimulation segment 620 which lasts approximately 5-7 minutes. The video has less brightness, movement, and activity while the audio is slower and has reduced volume. The third segment is low-stimulation 622 and lasts 10-20 minutes. This content has even less brightness, movement, and activity, while the audio is even slower and further reduced in volume. This segment is followed by content tagged as the nightlight track 624. This would include video only of a stationary image, or almost stationary with occasional movement designed to comfort, but not stimulate or awaken. This segment would last all night long. If the Play mode 616 is not selected, the unit checks to determine if the Loop mode is enabled 626. If the Loop mode is enabled 626, the initial engaging-stimulation content tracks 618 will play, followed by mild-stimulation tracks 620, followed by low-stimulation tracks 622, which continually replay. If the loop mode 626 is not selected, the unit looks to see if the Timer mode 636 is selected. If yes, then the Loop sequence 626 is played for the selected time duration, followed by the nightlight 624, if enabled, for the remainder of the night. If user content is not available when the unit is turned on 602 and not locked 604, then the unit will play pre-loaded fixed content 636, in the mode selected, play mode 616, Loop mode 626 or Timer mode 636.

The content can be programmed to play the higher-stimulation tracks first and only once, followed by a mild-stimulation tag played once, followed by low-stimulation tracks that may cycle or loop through several times—depending on how long the user or parent wants the content to play.

Another alternative would be chapter-based content, whereby a story continues from one night to the next. The user would be able to play a single chapter of the book each night, then jump to the mild-stimulation tracks, followed by low-stimulation tracks and the nightlight segment.

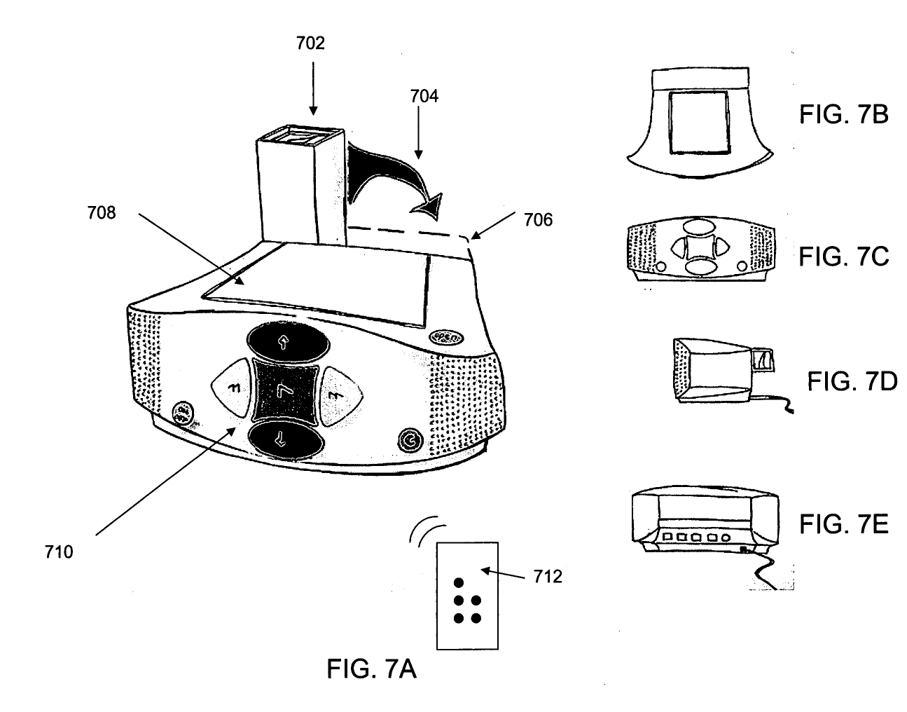

FIG. 7A illustrates an embodiment designed for adults. The projector column 702 would optimally be pointing at the ceiling, but can pivot 704 and point at a wall 706. The CD/DVD drive 708 would open at the top to accept CDs and DVDs. The controls 710 for this embodiment of the invention are located on the front and also accessible via a remote control 712 for easy access remotely.

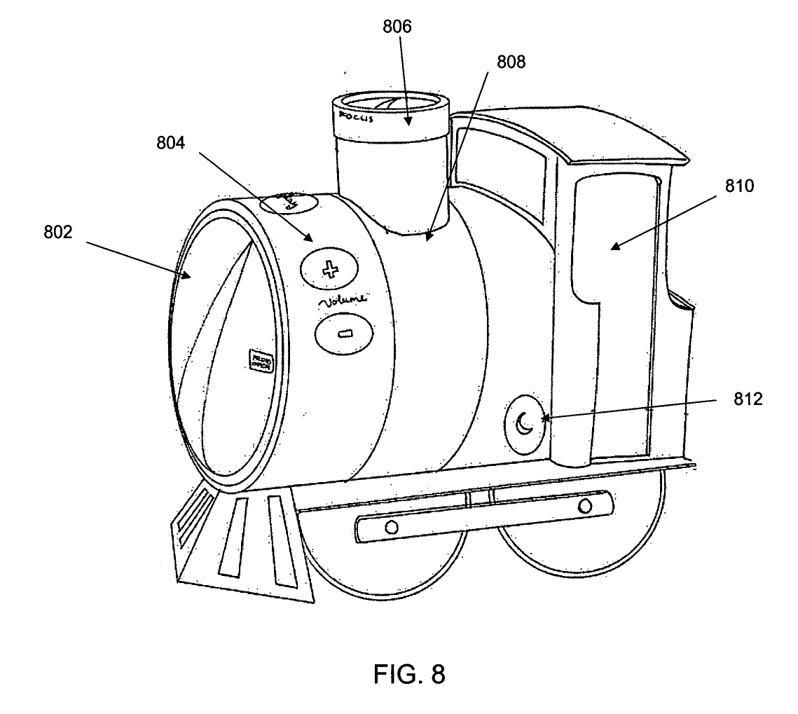

FIG. 8 shows another embodiment designed for children, presented as a train. The CD and DVD player 802 is at the front of the train. The control buttons 804 are easily accessible on the outside. The projector 806 can be rotated 808 so that it aims at either the ceiling or a wall. The speakers 810 are on the left and right side of the train. The night light button 812 is also easily accessible.

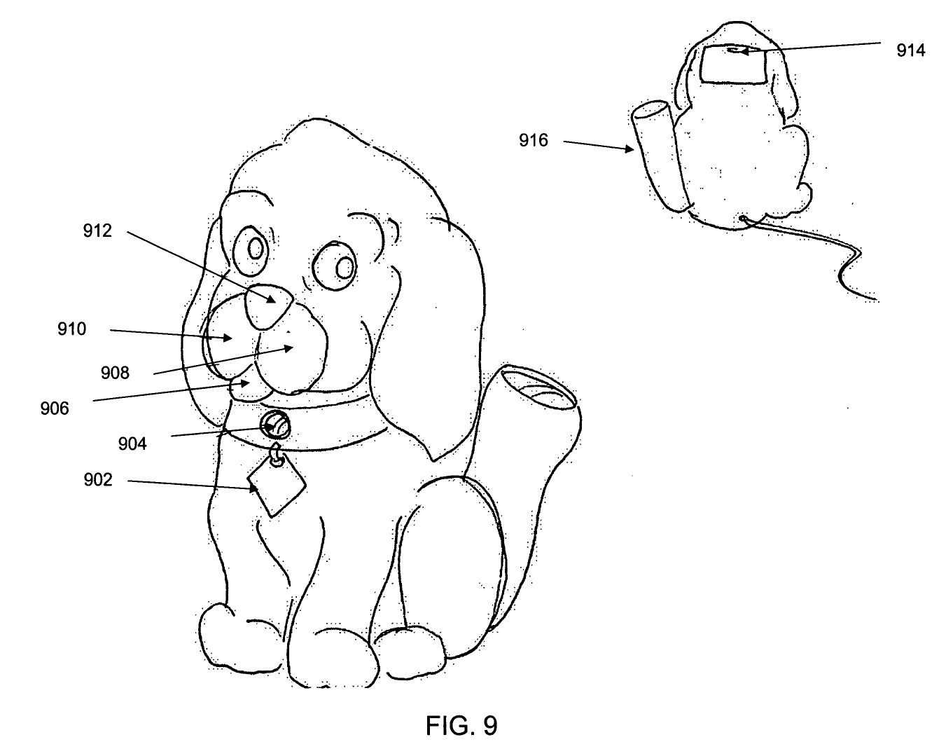

FIG. 9 shows another embodiment designed for children, presented as a puppy. This embodiment does not contain a CD/DVD player. The unit plays fixed content and content can be supported via external devices accessed through a USB connection. The on-off button 902 is presented as a dog tag. The night light 904 is located on the collar. Volume can be decreased 906 by pressing on the tongue, and increased 912 by pressing on the nose. The play button 910 and change mode button 908 are located on the front. The projector 916 is presented as the tail, and can move to point upwards at the ceiling (optimally) or at a wall. The parental controls 914 are located on the back.

Other features, aspects and objects of the invention can be obtained from a review of the figures and the claims. It is to be understood that other embodiments of the invention can be developed and fall within the spirit and scope of the invention and claims. The foregoing description of preferred embodiments of the present invention has been provided for the purposes of illustration and description. It is not intended to be exhaustive or to limit the invention to the precise forms disclosed. Many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

1. An integrated system to create relaxation in preparation for sleep, comprising:
a content player for video and synchronized audio content;
a projector to project video content; and
a set of speakers for synchronized audio content.

2. The system of claim 1, wherein the integrated system is masked as an animal.

3. The system of claim 2, wherein the projector is housed in a naturally-moving portion of the animal.

4. The system of claim 1, wherein the projector can pivot or rotate to project the video content on the ceiling or a wall.

5. The system of claim 1, wherein the player supports CDs and DVDs.

6. The system of claim 1, further comprising a CPU that reads content tags for the different types of content and determines the proper selection and sequence to play content.

7. The system of claim 1, further comprising an aromatherapy cartridge holder to warm gel cartridges to release aromas.

8. The system of claim 1, wherein the content player supports content from an external device or downloaded content.

9. The system of claim 1, wherein if a content source provides only audio content, the content player generates video content to accompany said audio content.

10. A method to create relaxation in preparation for sleep, comprising the steps of:
a. engaging interest through projecting engaging stimulation video content on the ceiling while playing synchronized music and audio content;
b. projecting mild stimulation content while reducing brightness and volume;
c. projecting low stimulation content while further reducing brightness and volume; and
d. ceasing audio content.

11. The method of claim 10, wherein user preferences comprise the ability to control the sequence and timing of transitions between different types of content, brightness, and volume.

12. The method of claim 11, wherein the user preferences further comprise the ability to filter colors and apply preset stylized effects on the projected video images.

13. The method of claim 10, wherein if the user awakens and wants help to return to sleep, low stimulation content will be played.

14. The method of claim 10, wherein wake-up content may be played to awaken the user at a specified time.

15. The method of claim 10, wherein the mild stimulation content does not have as many elements as the engaging content.

16. The method of claim 10, wherein the low stimulation content is repeatable.

17. The method of claim 10, further comprising a projected image as a night light being turned on after the audio content ceases.

18. A method to create relaxation in preparation for sleep by telling a bedtime story to a child, comprising the steps of:
a. engaging interest through projecting engaging illustrations or video on the ceiling while reading a story or a chapter of the story to the child;
b. transitioning to mild stimulation content while reducing brightness and volume;
c. further transitioning to low stimulation content and further reducing brightness and volume; and
d. ceasing projection of video and audio content.

19. The method of claim 18, wherein the parent reads the story to a child while accompanying background music is played and visuals are projected on to a ceiling or a wall.

20. The method of claim 18, further comprising a projected image as a night light being turned on after the audio content ceases.
